(19) United States
(12) Patent Application Publication
(10) Pub. No.: US 2025/0242864 A1
(43) Pub. Date: Jul. 31, 2025

(54) BODY MEMBER AND METHOD OF MANUFACTURING BODY MEMBER

(71) Applicant: FUTABA INDUSTRIAL CO., LTD., Okazaki-shi (JP)

(72) Inventor: Yuta Maki, Okazaki-shi (JP)

(21) Appl. No.: 19/039,117

(22) Filed: Jan. 28, 2025

(30) Foreign Application Priority Data
Jan. 30, 2024 (JP) 2024-011824

(51) Int. Cl. B62D 21/10; B62D 21/15; B62D 25/20; B62D 27/02

(52) U.S. Cl. CPC B62D 21/10; B62D 25/2009; B62D 27/023; B62D 21/155

(57) ABSTRACT

A body member includes a main member and a reinforcing member. The main member includes a top plate portion extending in an extending direction, a first side wall portion, a second side wall portion, a first flange, and a second flange. The first and second side wall portions each protrude from a corresponding one of two ends, in width direction, of the top plate portion. The first and second flanges are respectively provided at an end of the first side wall portion and an end of the second side wall portion, on a side opposite where the top plate portion is located. The reinforcing member is joined to an inner peripheral surface of the main member by welding performed in a patchwork method, and the top plate portion, the first and second side wall portions, the first and second flanges are formed by press forming performed in the patchwork method.

### CROSS-REFERENCE TO RELATED APPLICATION

This application claims the benefit of Japanese Patent Application No. 2024-011824 filed on Jan. 30, 2024 with the Japan Patent Office, the entire disclosure of which is incorporated herein by reference.

### BACKGROUND

The present disclosure relates to a body member that forms a part of a vehicle body and a method of manufacturing the body member.

As described in Japanese Unexamined Patent Application Publication No. 2008-222172, it is known that a rocker inner panel and a rocker reinforcement form a rocker, which is a square-pipe-shaped member located below a vehicle door. In the rocker disclosed in Japanese Unexamined Patent Application Publication No. 2008-222172, the rocker reinforcement has an inner peripheral surface to which an outer peripheral surface of an L-shaped reinforcement having an L-shaped cross section is welded.

### SUMMARY

However, in the rocker disclosed in the Japanese Unexamined Patent Application Publication No. 2008-222172, the L-shaped reinforcement includes seating faces that protrude from the outer peripheral surface of the L-shaped reinforcement, and such seating faces are welded to the rocker reinforcement. This configuration creates a gap between the L-shaped reinforcement and the rocker reinforcement, which may reduce fully plastic moment and crash performance of the rocker.

It is desirable that one aspect of the present disclosure is to promote the improvement in the crash performance.

One aspect of the present disclosure is a body member forming a part of a vehicle body that comprises a main member and a reinforcing member that are plate members. The main member includes a top plate portion, a first side wall portion, a second side wall portion, a first flange, and a second flange. The top plate portion is a plate-shaped portion extending in an extending direction. The first side wall portion and the second side wall portion each protrude from a corresponding one of two ends, in a width direction substantially orthogonal to the extending direction, of the top plate portion and face each other in the width direction. The first flange is provided at an end of the first side wall portion on a side opposite where the top plate portion is located and protrudes to a side opposite where the second side wall portion is located. The second flange is provided at an end of the second side wall portion on the side opposite where the top plate portion is located and protrudes to a side opposite where the first side wall portion is located. The reinforcing member is joined to an inner peripheral surface of the main member by welding performed in a patchwork method, and the top plate portion, the first side wall portion, the second side wall portion, the first flange, and the second flange are formed by press forming performed in the patchwork method.

According to the aforementioned configuration, the main member and the reinforcing member are welded together by performing a patchwork method, so that it possible to inhibit occurrence of a gap between the reinforcing member and the inner peripheral surface of the main member. This results in an improvement of fully plastic moment in the body member. Accordingly, the crash performance of the body member is improved.

In one aspect of the present disclosure, the main member may include a first portion and a second portion that are plate portions joined together by tailored blank welding.

This configuration makes it possible to form each of the portions of the main member from an appropriate material. As a result of this, it is possible to make the body member much easier to manufacture while inhibiting a decrease in the crash performance.

In one aspect of the present disclosure, the first portion and the second portion may be respectively located on a first end side and a second end side in the extending direction. The second portion has a length in the width direction that may increase toward the second end side. A tensile strength of the first portion may be higher than that of the second portion.

According to the aforementioned configuration, the second portion has a lower tensile strength than the first portion, so that it is possible to facilitate press forming. In addition, by forming the main member by tailored blank welding, the body member can be manufactured in a more favorable manner. The crash performance of the first portion can also be improved.

In one aspect of the present disclosure, the reinforcing member may be arranged to extend across a boundary between a first portion and a second portion in the main member and may be joined to the first portion and the second portion.

According to the aforementioned configuration, it is possible to favorably reinforce a welded area where the first portion and the second portion are welded together.

In one aspect of the present disclosure, the body member may be a rocker rear inner member to be mounted on a vehicle with the extending direction substantially coincident with a front-rear direction of the vehicle.

According to the aforementioned configuration, the crash performance of the rocker rear inner member is improved.

In one aspect of the present disclosure, a method of manufacturing the aforementioned body member may comprise joining the main member and the reinforcing member together by welding performed in the patchwork method and performing press forming, as a part of the patchwork method, on the main member and the reinforcing member that have been welded together.

According to the aforementioned configuration, the crash performance of the body member is improved.

In one aspect of the present disclosure, the method of manufacturing the aforementioned body member may further include forming the main member by joining a first plate and a second plate together by tailored blank welding.

According to the aforementioned configuration, it is possible to make the body member much easier to manufacture while inhibiting a decrease in the crash performance.

In one aspect of the present disclosure, according to the method of manufacturing the aforementioned body member, in the main member, a first portion formed from the first plate and a second portion formed from the second plate may be respectively located on a first end side and a second end side in the extending direction. The second portion has a length in the width direction that may increase toward the second end side. A tensile strength of the first plate is higher than that of the second plate.

According to the aforementioned configuration, the second plate has a lower tensile strength than the first plate, so that it is possible to facilitate press forming. In addition, by forming the main member by tailored blank welding, the body member can be manufactured in a more favorable manner. The crash performance of the first portion can also be improved.

In one aspect of the present disclosure, according to the method of manufacturing the aforementioned body member, the reinforcing member may be arranged to extend across a boundary between the first portion formed from the first plate and the second portion formed from the second plate in the main member and may be joined to the first portion and the second portion.

According to the aforementioned configuration, it is possible to favorably reinforce a welded area where the first portion and the second portion are welded together.

In one aspect of the present disclosure, according to the method of manufacturing the aforementioned body member, the body member may be a rocker rear inner member to be mounted on a vehicle with the extending direction substantially coincident with a front-rear direction of the vehicle.

According to the aforementioned configuration, the crash performance of the rocker rear inner member is improved.

### BRIEF DESCRIPTION OF THE DRAWINGS

Embodiments of the present disclosure will be described hereinafter with reference to the accompanying drawings, in which:

FIG. 1 is an explanatory diagram of a vehicle body including a rocker rear inner member of a first embodiment:

FIG. 2 is a perspective view of the rocker rear inner member of the first embodiment as seen from an inner peripheral surface of the rocker rear inner member thereof:

FIG. 3A is a front view of the rocker rear inner member of the first embodiment:

FIG. 3B is a bottom view of the rocker rear inner member of the first embodiment as seen from a bottom of the rocker rear inner member thereof:

FIG. 3C is a plan view of the rocker rear inner member of the first embodiment as seen from a top of the rocker rear inner member thereof:

FIG. 4A is a side view of the rocker rear inner member of the first embodiment as seen from a front end of the rocker rear inner member thereof:

FIG. 4B is a side view of the rocker rear inner member of the first embodiment as seen from a rear end of the rocker rear inner member thereof:

FIG. 4C is a cross sectional view taken along the line IVC-IVC in FIG. 3A:

FIG. 4D is a cross sectional view taken along the line IVD-IVD in FIG. 3A:

FIG. 5 is a plan view of a joined material of the first embodiment;

FIG. 6 is a plan view of a main blank material of a second embodiment:

FIG. 7 is a plan view of a joined material of the second embodiment;

FIG. 8 is a perspective view of the rocker rear inner member of the second embodiment as seen from an inner peripheral surface of the rocker rear inner member thereof:

FIG. 9A is a front view of the rocker rear inner member of the second embodiment:

FIG. 9B is a bottom view of the rocker rear inner member of the second embodiment as seen from a bottom of the rocker rear inner member thereof; and

FIG. 9C is a plan view of the rocker rear inner member of the second embodiment as seen from a top of the rocker rear inner member thereof.

### DETAILED DESCRIPTION OF EXEMPLARY EMBODIMENTS

### 1. First Embodiment

### [(1) Rocker Rear Inner Member]

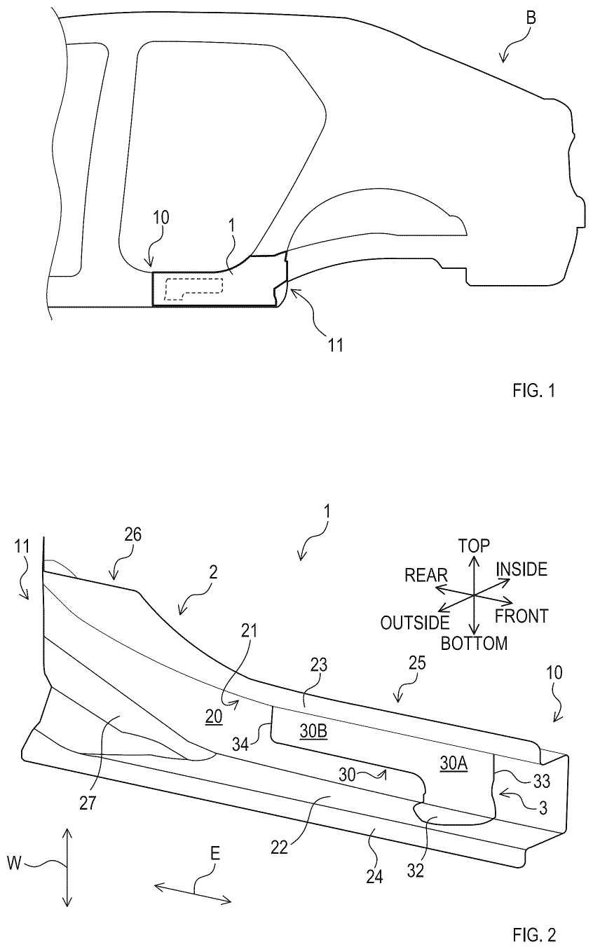

A rocker rear inner member 1 of a first embodiment forms a part of a vehicle body B and is located on frames under left and right rear doors of the vehicle (see FIG. 1). The rocker rear inner member 1 is arranged to extend in a front-rear direction of the vehicle. A rear end 11 of the rocker rear inner member 1 is positioned near the rear wheels of the vehicle. In one example, the rocker rear inner member 1 shown in FIGS. 2 through 4D is provided on a right side of the vehicle. In the following description, a center side of the vehicle and end sides of the vehicle, in a right-left direction of the vehicle, are simply referred to as an inside of the vehicle and an outside of the vehicle, respectively. The rocker rear inner member 1 is manufactured by performing a patchwork method and includes a main member 2 and a reinforcing member 3 that are plate members (see FIG. 2).

### [(2) Main Member]

The main member 2 includes a top plate portion 20, a first side wall portion 21, a second side wall portion 22, a first flange 23, and a second flange 24 (see FIGS. 2 to 4D).

The top plate portion 20 is a plate-shaped portion that extends in an extending direction E, the extending direction being substantially coincident with the front-rear direction of the vehicle. The top plate portion 20 also expands in a vertical direction of the vehicle.

The first side wall portion 21 and the second side wall portion 22 each protrude to the outside of the vehicle from a corresponding one of two ends, in a width direction W substantially orthogonal to the extending direction E, of the top plate portion 20. The first side wall portion 21 and the second side wall portion 22 face each other in the width direction W. The width direction W substantially coincides with the vertical direction, and the first side wall portion 21 is located on an upper side in the width direction and the second side wall portion 22 is located on a lower side in the width direction.

A first flange 23 is provided at an end of the first side wall portion 21 on a side opposite where the top plate portion 20 is located and protrudes to a side opposite where the second side wall portion 22 is located. The second flange 24 is provided at an end of the second side wall portion 22 on the side opposite where the top plate portion 20 is located and protrudes to a side opposite where the first side wall portion 21 is located.

The first flange 23, the second flange 24, the top plate portion 20 are aligned in the right-left direction of the vehicle, and the first flange 23 and the second flange 24 are located on the outside of the vehicle and the top plate portion 20 is located on the inside of the vehicle.

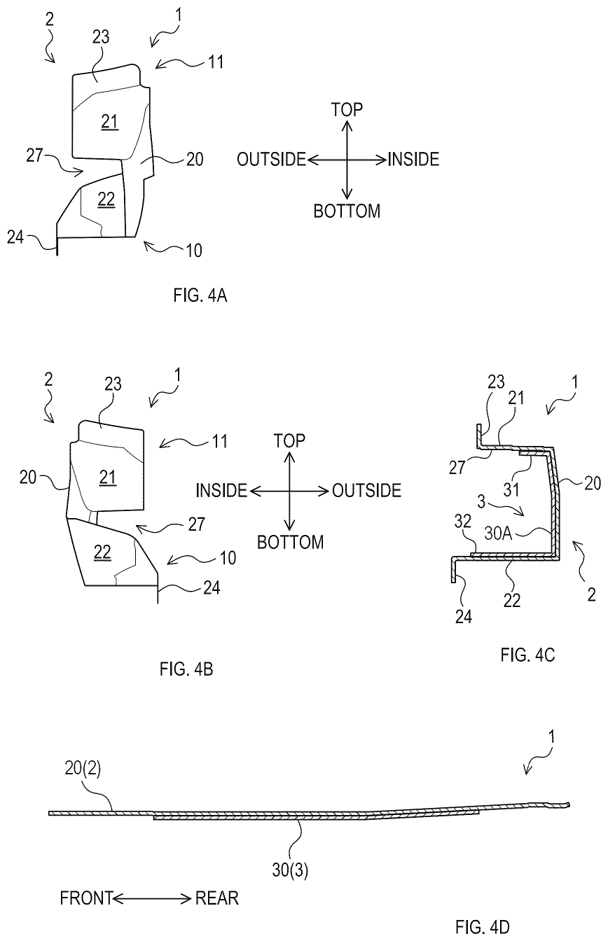

The top plate portion 20, the first side wall portion 21, the second side wall portion 22, the first flange 23, and the second flange 24 extend from a front end 10 to a rear end 11 of the rocker rear inner member 1. A cross section of the main member 2 orthogonal to the extending direction E has a so-called hat shape (see FIGS. 4A through 4C).

In addition, the main member 2 includes a front side portion 25 and a rear side portion 26 that are aligned in the front-rear direction of the vehicle.

The front side portion 25 is positioned at the front side and has a length in the width direction W (hereinafter simply referred to as a width) that is substantially uniform.

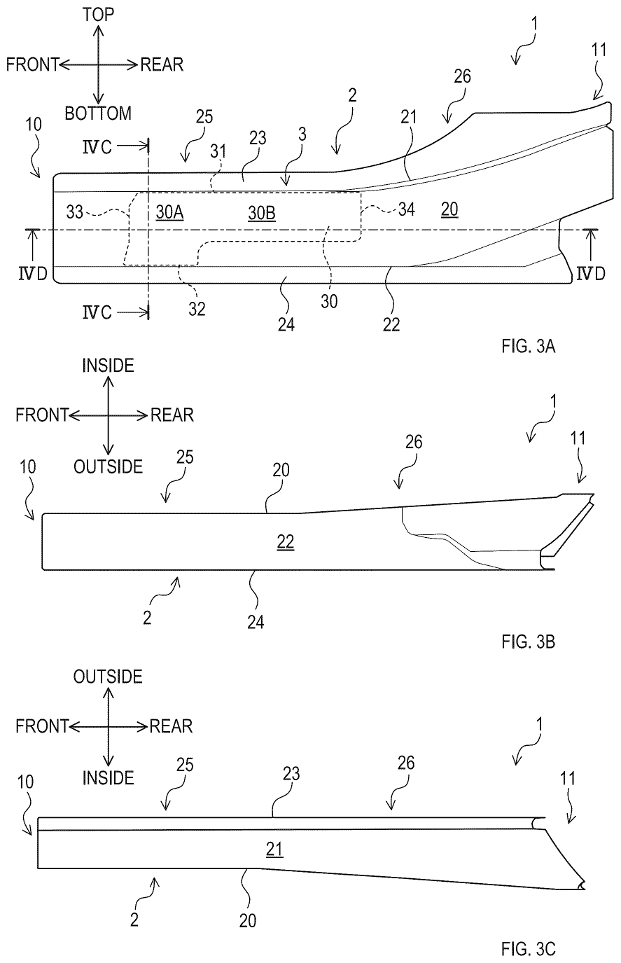

The rear side portion 26 is positioned at the rear side and has the width that increases toward the rear side (see FIGS. 2, 3A). More specifically, in the rear side portion 26, the second flange 24 extends substantially straight along the extending direction E and the first flange 23 curves upward toward the rear side, so that a distance between the first flange 23 and the second flange 24 increases toward the rear side. The top plate portion 20 in the rear side portion 26 slopes upward toward the rear side, although a width of the top plate portion 20 is substantially uniform. In the rear side portion 26, a distance between the first side wall portion 21 and the second side wall portion 22 also increases toward the rear side. Furthermore, in the rear side portion 26, a distance between the first flange 23 and the top plate portion 20 and a distance between the second flange 24 and the top plate portion 20 (in other words, heights) increase toward the rear side (see FIGS. 3B, 3C).

### [(3) Reinforcing Member]

The reinforcing member 3 is welded to an inner peripheral surface 27 of the main member 2 by performing a patchwork method (see FIGS. 2, 3A, 4C, and 4D). The reinforcing member 3 includes a main portion 30, a first side portion 31, and a second side portion 32.

The main portion 30 is a plate-shaped portion that extends in the extending direction E and overlaps with the top plate portion 20 of the main member 2. The main portion 30 includes a wide-width portion 30A and a narrow-width portion 30B that are aligned in the extending direction E. The wide-width portion 30A is positioned on the front side in the front-rear direction of the vehicle, relative to the narrow-width portion 30B, and forms a front end portion 33 of the reinforcing member 3. The narrow-width portion 30B forms a rear end portion 34 of the reinforcing member 3. The wide-width portion 30A is wider than the narrow-width portion 30B and expands across the width direction W of the top plate portion 20. The narrow-width portion 30B is narrower than the top plate portion 20 and has a substantially uniform width. The narrow-width portion 30B is adjacent to the first side wall portion 21.

The first side portion 31 is a wall-shaped portion that protrudes from an upper end of the main portion 30 to the outside of the vehicle. The first side portion 31 extends from a front end to a rear end of the main portion 30. The first side portion 31 overlaps with the first side wall portion 21.

The second side portion 32 is a wall-shaped portion that protrudes from an entire edge of a lower end of the wide-width portion 30A and overlaps with the second side wall portion 22. The second side portion 32 has a shape in which a center in the extending direction E of the second side portion 32 protrudes to the outside of the vehicle.

The reinforcing member 3 is joined to the front side portion 25 and the rear side portion 26. In one example, the wide-width portion 30A is joined to the front side portion 25. In addition, the narrow-width portion 30B is joined to the front side portion 25 and the rear side portion 26 in such a way that the rear end portion 34 of the reinforcing member 3 reaches the rear side portion 26. However, without being limited to this configuration, the reinforcing member 3 may be joined to the front side portion 25 only.

### [(4) Method of Manufacturing Rocker Rear Inner Member]

As described above, the rocker rear inner member 1 is formed by the patchwork method. The method of manufacturing the rocker rear inner member 1 includes a welding process and a press forming process in the patchwork method.

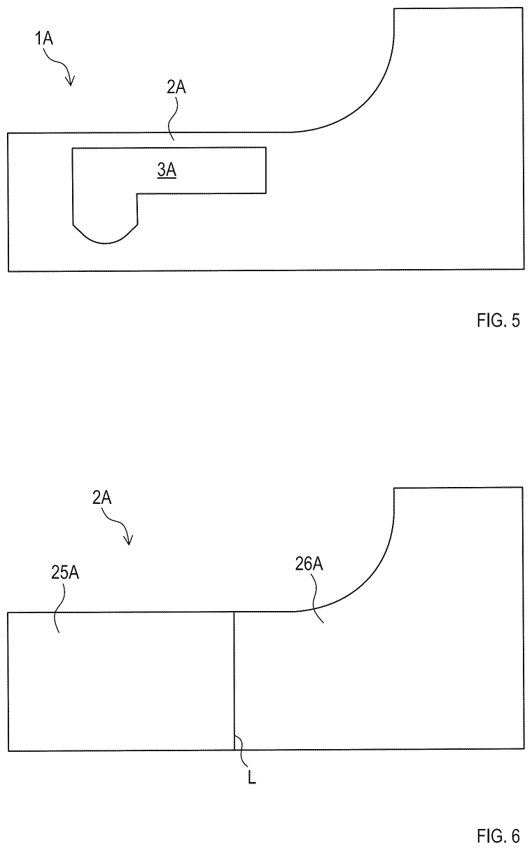

In the welding process, a main blank material 2A and a reinforcing blank material 3A are joined together by welding (in one example, by spot-welding) to form a joined material 1A (see FIG. 5). The main blank material 2A and the reinforcing blank material 3A are blank materials for forming the main member 2 and the reinforcing member 3, respectively, and are processed with shears to obtain shapes that correspond to the main member 2 and the reinforcing member 3. In one example, these materials are L-shaped.

For example, the main blank material 2A and the reinforcing blank material 3A may be made of steel, more specifically, high-tensile steel. In addition, in one example, the reinforcing blank material 3A may be made of steel with a tensile strength of 980 MPa or less.

In the subsequent press forming process, in one example, cold press forming is performed on the joined material 1A. This results in forming the rocker rear inner member 1 as shown in figures such as FIG. 2. Specifically, parts of the main member 2, namely the top plate portion 20, the first side wall portion 21, the second side wall portion 22, the first flange 23, and the second flange 24, and parts of the reinforcing member 3, namely the main portion 30, the first side portion 31, and the second side portion 32 are formed in the press forming process.

### 2. Second Embodiment

### [(1) Summary]

Although the rocker rear inner member 1 of a second embodiment has the same configuration as that of the first embodiment, the second embodiment differs from the first embodiment in that the main member 2 is formed by tailored blank welding. Specifically, a method of manufacturing the rocker rear inner member 1 of the second embodiment includes the tailored blank welding process as well as the welding process and the press forming process similar to those in the first embodiment. In the following, a description will be given of differences between the rocker rear inner member 1 of the second embodiment and that of the first embodiment.

### [(2) Tailored Blank Welding Process]

In the tailored blank welding process, tailored blank welding is performed on a front-side blank material 25A and a rear-side blank material 26A, thereby forming the main blank material 2A, which has the same shape as that of the first embodiment (see FIG. 6).

The front-side blank material 25A and the rear-side blank material 26A are blank materials for forming the front side portion 25 and the rear side portion 26 in the main member 2, respectively, and are processed with shears to obtain shapes that correspond to the front side portion 25 and the rear side portion 26 after the press forming process. In one example, the front-side blank material 25A is substantially rectangular in shape and the rear-side blank material 26A is L-shaped.

Additionally, in one example, a material of the front-side blank material 25A has a higher tensile strength than a material of the rear-side blank material 26A. Specifically, for example, materials of the front-side blank material 25A and the rear-side blank material 26A may be steel or high-tensile steel, more specifically, high-tensile steel with a tensile strength of 590 MPa or more. Further, more specifically, these materials may be high-tensile steel with a tensile strength of 780 MPa or more. Furthermore, more specifically, the material of the front-side blank material 25A may be high-tensile steel with a tensile strength of 980 MPa or more.

Needless to say, the materials of the front-side blank material 25A and the rear-side blank material 26A may be determined appropriately. Specifically, for example, a tensile strength of the material of the front-side blank material 25A may be less than or equal to a tensile strength of the material of the rear-side blank material 26A.

[(3) Welding Process and Press forming Process]

In the subsequent welding process and press forming process, by performing the patchwork method as performed in the first embodiment, the rocker rear inner member 1 is formed from the main blank material 2A, which is formed in the tailored blank welding process, and the reinforcing blank material 3A.

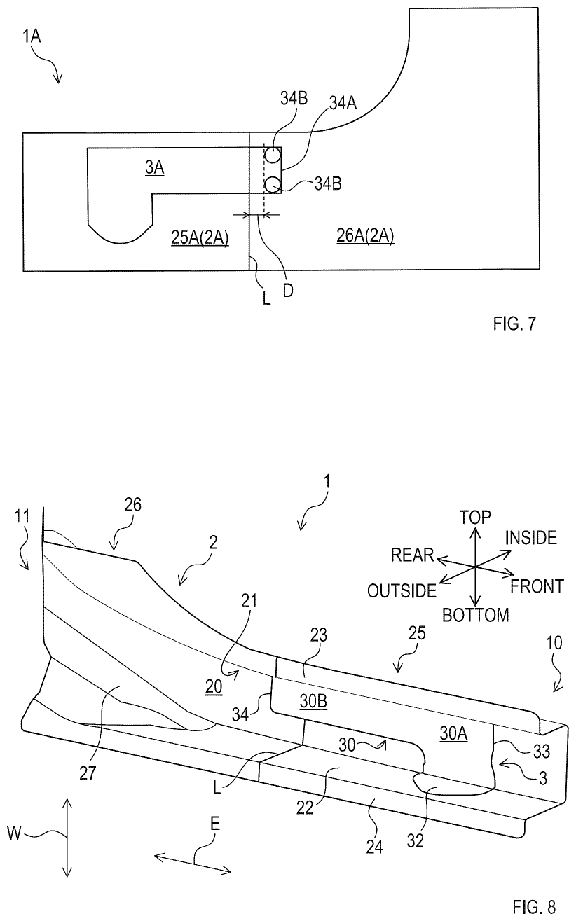

Specifically, in the welding process, as in the first embodiment, the main blank material 2A and the reinforcing blank material 3A are welded together to form the joined material 1A (see FIG. 7). At this point of time, the reinforcing blank material 3A is arranged to extend across a Tailor Welded Blank (TWB) line L and is joined to the front-side blank material 25A and the rear-side blank material 26A. The TWB line L corresponds to a boundary between the front-side blank material 25A and the rear-side blank material 26A. This means that, when welding the front-side blank material 25A and the rear-side blank material 26A together, a Heat-Affected Zone (HAZ) may form around the TWB line L.

Specifically, a rear end portion 34A of the reinforcing blank material 3A is in contact with the rear-side blank material 26A and a welded portion 34B near the rear end portion 34A of the reinforcing blank material 3A is welded to the rear-side blank material 26A by spot-welding. The rear end portion 34A of the reinforcing blank material 3A corresponds to the rear end portion 34 of the reinforcing member 3. In the second embodiment, in one example, two welded portions 34B are formed such that each portion is located near a corresponding one of two ends of the rear end portion 34A of the reinforcing blank material 3A. However, a position and number of the welded portion 34B may be determined appropriately. Further, a distance D between the welded portion 34B and the TWB line L is 5 mm or more, in one example. Needless to say, the distance D is not limited to this and may be less than 5 mm. Furthermore, the rear end portion 34A of the reinforcing blank material 3A may be in contact with the front-side blank material 25A and the welded portion 34B may be welded to the front-side blank material 25A by spot-welding.

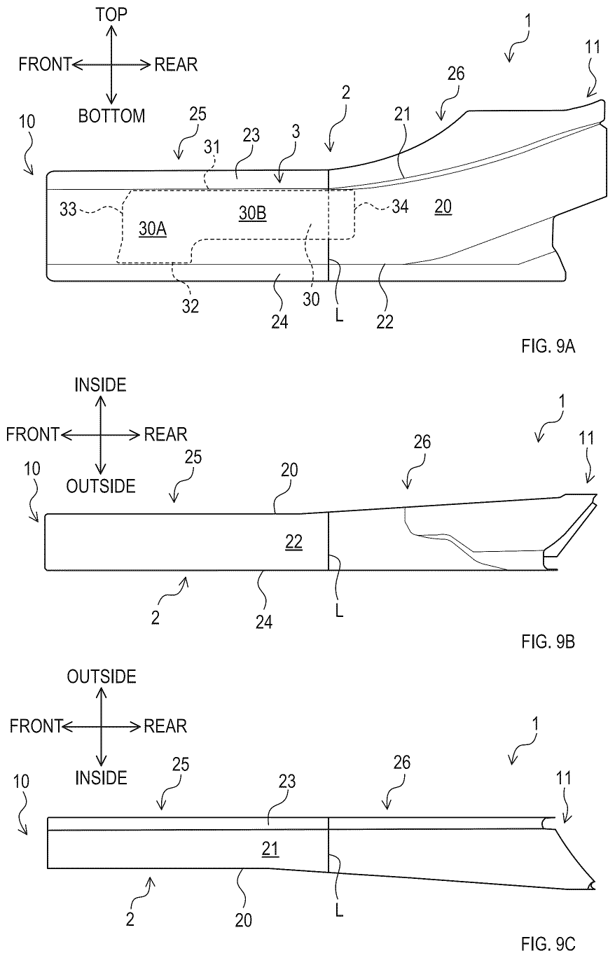

Furthermore, in the subsequent press forming process, as in the first embodiment, cold press forming is performed on the joined material 1A, in one example. This results in forming the rocker rear inner member 1 (see FIGS. 8 through 9C).

### [(4) Rocker Rear Inner Member]

The rocker rear inner member 1 of the second embodiment has a configuration similar to that of the first embodiment. However, the rocker rear inner member 1 of the second embodiment differs from that of the first embodiment in that the front side portion 25 and the rear side portion 26 of the main member 2 are formed from the front-side blank material 25A and the rear-side blank material 26A, respectively, which are joined together by tailored blank welding (see FIGS. 8 to 9C).

Specifically, at a substantial center of the main member 2 in the extending direction E, there is positioned the TWB line L that extends in a direction substantially orthogonal to the extending direction E. Further, in the front-rear direction of the vehicle, the front side portion 25 is located on the front side relative to the TWB line L and the rear side portion 26 is located on the rear side relative to the TWB line L.

In addition, the reinforcing member 3 is arranged on the inner peripheral surface 27 of the main member 2 to extend across the TWB line L, and joined to the front side portion 25 and the rear side portion 26.

### 3. Effects

(1) According to the first and second embodiments, the main member 2 and the reinforcing member 3 are welded together by performing the patchwork method. This makes it possible to inhibit occurrence of a gap between the reinforcing member 3 and the inner peripheral surface 27 of the main member 2, so that fully plastic moment of the rocker rear inner member 1 is improved. This results in improvement in the crash performance (i.e., strength) of the rocker rear inner member 1.

(2) In addition, when the reinforcing member 3 is made of high-tensile steel with a tensile strength of 1180 MPa or more, welding a nut or other member to the reinforcing member 3 increases the risk of occurrence of delayed fracture and thus reinforcement with a patch is required. Such reinforcement causes an increase in the weight of the rocker rear inner member 1 and an increase in the number of manufacturing processes.

In contrast, according to the second embodiment, the crash performance of the rocker rear inner member 1 is improved by using the tailored blank welding, so that it is possible to make the reinforcing member 3 of a material with a tensile strength of 980 MPa or less. This can reduce the risk of occurrence of delayed fracture, and eliminates the need for the patch even when a nut or other member is welded to the reinforcing member 3. As a result of the elimination of the patch, it is possible to reduce the weight of the rocker rear inner member 1 and the number of manufacturing processes.

(3) In addition, in recent years, the number of vehicles powered by a motor has increased. Such vehicles tend to be heavier because their weight is affected by a battery or the like, and thus a load to be applied to the rocker rear inner member 1 in the event of a collision would increase. In contrast, according to the first and second embodiments, the rocker rear inner member I can achieve both an improvement in the crash performance and a reduction in weight. This makes it possible to respond favorably to the increase in the vehicle weight.

(4) In addition, the main member 2 of the second embodiment is formed by joining the front-side blank material 25A and the rear-side blank material 26A together by tailored blank welding. This allows each of the portions of the main member 2 to be made of an appropriate material. As a result of this, it is possible to make the rocker rear inner member 1 much easier to manufacture while inhibiting a decrease in the crash performance.

(5) In addition, the rear side portion 26 in the main member 2 has a shape with increased width and height toward the rear side, and such a shape is more difficult to form by press forming than a shape of the front side portion 25. To address this issue, in the second embodiment, the material of the rear side portion 26 has a lower tensile strength than the material of the front side portion 25. This can facilitate formation of the rear side portion 26 by press forming and, as a result of the formation of the main member 2 by tailored blank welding, it is possible to manufacture favorably the rocker rear inner member 1. The crash performance of the front side portion 25 can be also improved.

(6) In addition, in the second embodiment, the reinforcing member 3 is arranged to extend across the TWB line L and is welded to the front side portion 25 and the rear side portion 26. This configuration makes it possible to favorably reinforce a welded area where the front side portion 25 and the rear side portion 26 are joined together and the HAZ formed around the TWB line L.

(7) In addition, in the second embodiment, the rocker rear inner member 1 is formed by performing the patchwork method on the main blank material 2A formed by tailored blank welding and the reinforcing blank material 3A. In other words, welding of the main member 2 and the reinforcing member 3 after press forming is not necessary. This can mitigate the effect of deformation caused by press forming compared to the case where press forming is performed separately on the main blank material 2A and the reinforcing blank material 3A to form the main member 2 and the reinforcing member 3, respectively, which are then welded together to manufacture the rocker rear inner member 1.

Thus, it is possible to suppress a margin required for design values of the rocker rear inner member 1. In one example, when the main blank material 2A and the reinforcing blank material 3A are welded together by the patchwork method, the distance D between the welded portion 34B in the reinforcing blank material 3A and the TWB line L can be smaller than conventional values (in one example, 5 mm or more). As described above, according to the second embodiment, the degree of freedom in designing the rocker rear inner member 1 is increased.

### 4. Other Embodiments

(1) Any body member that forms a part of the vehicle body may be formed similarly to the rocker rear inner member 1 of the first and second embodiments. Even in such a case, the aforementioned effects can be achieved.

(2) Two or more functions of a single element in the above-described embodiments may be achieved by two or more elements or a single function of a single element may be achieved by two or more elements. The functions of two or more elements may be achieved by a single element or a single function of two or more elements may be achieved by a single element. Part of the configuration in the above-described embodiments may be omitted. Furthermore, at least part of the configuration of the above-described embodiments may be added to or replaced by a configuration of other embodiments.

### 5. Correspondence Relationship of Terms

In the second embodiment, the front side portion 25 and the rear side portion 26 correspond to one example of a first portion and one example of a second portion, respectively. The front-side blank material 25A and the rear-side blank material 26A correspond to one example of a first plate and one example of a second plate, respectively.

### 6. Technical Idea Disclosed Herein

### [Item 1]

A body member forming a part of a vehicle body, the body member comprising a main member and a reinforcing member that are plate members, the main member including:
a top plate portion that is a plate-shaped portion extending in an extending direction:
a first side wall portion and a second side wall portion each protruding from a corresponding one of two ends, in a width direction substantially orthogonal to the extending direction, of the top plate portion, the first side wall portion and the second side wall portion facing each other in the width direction:
a first flange provided at an end of the first side wall portion on a side opposite where the top plate portion is located, the first flange protruding to a side opposite where the second side wall portion is located; and
a second flange provided at an end of the second side wall portion on the side opposite where the top plate portion is located, the second flange protruding to a side opposite where the first side wall portion is located, and
the reinforcing member being joined to an inner peripheral surface of the main member by welding performed in a patchwork method, and the top plate portion, the first side wall portion, the second side wall portion, the first flange, and the second flange being formed by press forming performed in the patchwork method.

### [Item 2]

The body member according to item 1,
wherein the main member includes a first portion and a second portion that are plate portions joined together by tailored blank welding.

### [Item 3]

The body member according to item 2,
wherein the first portion and the second portion are respectively located on a first end side and a second end side in the extending direction,
wherein the second portion has a length in the width direction that increases toward the second end side, and
wherein a tensile strength of the first portion is higher than that of the second portion.

### [Item 4]

The body member according to item 2 or 3,
wherein the reinforcing member is arranged to extend across a boundary between the first portion and the second portion in the main member and is joined to the first portion and the second portion.

### [Item 5]

The body member according to any one of items 1 through 4,
wherein the body member is a rocker rear inner member to be mounted on a vehicle with the extending direction substantially coincident with a front-rear direction of the vehicle.

### [Item 6]

A method of manufacturing the body member according to item 1, the method comprising:
joining the main member and the reinforcing member together by welding performed in the patchwork method; and press forming, in the patchwork method, the main member and the reinforcing member that have been welded together.

### [Item 7]

The method of manufacturing the body member according to item 6, the method further comprising:
forming the main member by joining a first plate and a second plate together by tailored blank welding.

What is claimed is:

1. A body member forming a part of a vehicle body, the body member comprising a main member and a reinforcing member that are plate members,
the main member including:
a top plate portion that is a plate-shaped portion extending in an extending direction;
a first side wall portion and a second side wall portion each protruding from a corresponding one of two ends, in a width direction substantially orthogonal to the extending direction, of the top plate portion, the first side wall portion and the second side wall portion facing each other in the width direction;
a first flange provided at an end of the first side wall portion on a side opposite where the top plate portion is located, the first flange protruding to a side opposite where the second side wall portion is located; and
a second flange provided at an end of the second side wall portion on the side opposite where the top plate portion is located, the second flange protruding to a side opposite where the first side wall portion is located, and
the reinforcing member being joined to an inner peripheral surface of the main member by welding performed in a patchwork method, and the top plate portion, the first side wall portion, the second side wall portion, the first flange, and the second flange being formed by press forming performed in the patchwork method.

2. The body member according to claim 1,
wherein the main member includes a first portion and a second portion that are plate portions joined together by tailored blank welding.

3. The body member according to claim 2,
wherein the first portion and the second portion are respectively located on a first end side and a second end side in the extending direction,
wherein the second portion has a length in the width direction that increases toward the second end side, and
wherein a tensile strength of the first portion is higher than that of the second portion.

4. The body member according to claim 2,
wherein the reinforcing member is arranged to extend across a boundary between the first portion and the second portion in the main member and is joined to the first portion and the second portion.

5. The body member according to claim 1,
wherein the body member is a rocker rear inner member to be mounted on a vehicle with the extending direction substantially coincident with a front-rear direction of the vehicle.

6. A method of manufacturing the body member according to claim 1, the method comprising:
joining the main member and the reinforcing member together by welding performed in the patchwork method; and
press forming, in the patchwork method, the main member and the reinforcing member that have been welded together.

7. The method of manufacturing the body member according to claim 6, the method further comprising:
forming the main member by joining a first plate and a second plate together by tailored blank welding.

8. The method of manufacturing the body member according to claim 7,
wherein, in the main member, a first portion formed from the first plate and a second portion formed from the second plate are respectively located on a first end side and a second end side in the extending direction,
wherein the second portion has a length in the width direction that increases toward the second end side, and
wherein a tensile strength of the first plate is higher than that of the second plate.

9. The method of manufacturing the body member according to claim 7,
wherein the reinforcing member is arranged to extend across a boundary between a first portion formed from the first plate and a second portion formed from the second plate in the main member and is joined to the first portion and the second portion.

10. The method of manufacturing the body member according to claim 6,
wherein the body member is a rocker rear inner member to be mounted on a vehicle with the extending direction substantially coincident with a front-rear direction of the vehicle.
